(19) United States
(12) Patent Application Publication
(10) Pub. No.: US 2008/0311482 A1
(43) Pub. Date: Dec. 18, 2008

(54) Radiation-crosslinking and thermally crosslinking PU systems comprising iminooxadiazinedione

(75) Inventors: Nicolas Stockel, Koln (DE); Friedrich-Karl Bruder, Krefeld (DE); Frank Richter, Leverkusen (DE)

Correspondence Address: Connolly Bove Lodge & Hutz LLP, 1007 North Orange Street, P.O. Box 2207, Wilmington, DE, 19899-2207, US

(73) Assignee: Bayer MaterialScience AG, Leverkusen (DE)

(21) Appl. No.: 12/100,754

(22) Filed: Apr. 10, 2008

Related U.S. Application Data
(60) Provisional application No. 60/922,989, filed on Apr. 11, 2007.

(51) Int. Cl. G03C 1/73

(52) U.S. Cl. 430/2

(57) ABSTRACT

The present invention relates to polyurethane compositions which cure by radiation and thermal action with crosslinking, and use thereof for the production of holographic media. The polyurethane compositions of the invention comprise A) one or more iminooxadiazinedione-group-containing polyisocyanates, B) one or more polyfunctional, isocyanate-reactive compounds, C) one or more compounds having groups which on exposure to actinic radiation with ethylenically unsaturated compounds with polymerization (radiation-curing groups), D) optionally one or more free radical stabilizers and E) one or more photoinitiators.

### CROSS-REFERENCE TO RELATED APPLICATION

This application claims priority under 35 U.S.C. § 119(e) to provisional application Ser. No. 60/922,989, filed Apr. 11, 2007 the disclosure of which is incorporated by reference for all useful purposes

### FIELD OF THE INVENTION

The present invention relates to polyurethane systems which cure by radiation and thermal action with crosslinking, and the use thereof for the production of holographic media.

### BACKGROUND OF THE INVENTION

In the production of holographic media, as described in U.S. Pat. No. 6,743,552, information is stored in a polymer layer which substantially consists of a matrix polymer and very special polymerizable monomers distributed uniformly therein. This matrix polymer may be based on polyurethane. It is prepared as a rule starting from NCO-functional prepolymers which are crosslinked with polyols, such as polyethers or polyesters, with urethane formation.

However, what is problematic is that low viscosities of the reaction mixtures are required for an efficient production of such holographic media but, on the other hand, solvents for setting viscosity are undesired. A further problem is that the curing under urethanization often lasts too long.

Systems comprising polyisocyanates, polyols and radiation-curing compounds, such as photochemically crosslinking reactive diluents, are known in individual cases from the area of coating technology (U.S. Pat. No. 4,247,578, DE 197 09 560). Polyol components mentioned are substantially polyether- or polyester-based ones or polyacrylatepolyols. However, indications as to how a rapid curing can be achieved at low viscosity are not given.

### SUMMARY OF THE INVENTION

It was an object of the present invention to provide polyurethane systems which are suitable for the production of storage layers for holographic storage media and which, in the solvent-free state, have relatively low viscosities and in addition a rapid curing.

It has now been found that excellent compatibility of matrix polymer with the unsaturated monomers is obtained precisely when iminooxadiazinedione-group-containing polyisocyanates are used as a building block for the matrix polymers.

The invention relates to polyurethane systems comprising
A) iminooxadiazinedione-group-containing polyisocyanates,
B) polyfunctional, isocyanate-reactive compounds,
C) compounds having groups which react on exposure to actinic radiation with ethylenically unsaturated compounds with polymerization (radiation-curing groups),
D) optionally free radical stabilizers and
E) photoinitiators.

### DETAILED DESCRIPTION OF THE INVENTION

As used herein in the specification and claims, including as used in the examples and unless otherwise expressly specified, all numbers may be read as if prefaced by the word “about”, even if the term does not expressly appear. Also, any numerical range recited herein is intended to include all sub-ranges subsumed therein.

Polyisocyanates of component A which may be used are per se all NCO-functional compounds having at least one iminooxadiazinedione group.

These may have an aromatic, araliphatic, aliphatic or cycloaliphatic basis. Iminooxadiazinedione-group-free mono-, di-, tri- or polyisocyanates can also be used in addition.

The basis for such isocyanates are, for example, butylene diisocyanate, hexamethylene diisocyanate (HDI), isophorone diisocyanate (IPDI), 1,8-diisocyanato-4-(isocyanatomethyl)octane, 2,2,4- and/or 2,4,4-trimethylhexamethylene diisocyanate, the isomeric bis(4,4′-isocyanatocyclohexyl)methanes and mixtures thereof having any desired isomer content, isocyanatomethyl-1,8-octane diisocyanate, 1,4-cyclohexylene diisocyanate, the isomeric cyclohexanedimethylene diisocyanates, 1,4-phenylene diisocyanate, 2,4- and/or 2,6-toluene diisocyanate, 1,5-naphthylene diisocyanate, 2,4′- or 4,4′-diphenylmethane diisocyanate and/or triphenylmethane 4,4′,4″-triisocyanate are suitable.

The use of derivatives of monomeric di- or triisocyanates having urethane, urea, carbodiimides, acylurea, isocyanurate, allophanate, biuret, oxadiazinetrione, uretdione and/or iminooxadiazinedione structures is also possible.

The use of polyisocyanates based on aliphatic and/or cycloaliphatic di- or triisocyanates of the abovementioned type is preferred.

The proportion of iminooxadiazinedione-group-free isocyanates, based on the total amount of component A), is preferably not more than 90% by weight, particularly preferably not more than 50% by weight and very particularly preferably not more than 40% by weight.

Iminooxadiazinedione-group-containing polyisocyanates based on hexamethylene diisocyanate are particularly preferred.

The proportion of iminooxadiazinedione groups, based on the total amount of trimer structures in the polyisocyanates of the present invention, is preferably more than 30 mol %, particularly preferably more than 35 mol %, very particularly preferably more than 40 mol %.

Such polyisocyanates having relatively high iminooxadiazinedione proportions are, according to EP-A 0 798 299, obtainable by trimerization of corresponding isocyanate monomers or mixtures of different monomers in the presence of special catalysts. Particularly suitable catalysts are hydrogen (poly)fluorides of the composition {M[nF⁻*(HF)ₘ]}, in which m/n>0 and M is a cation having a charge of n or a n-valent organic radical.

The NCO groups of the compounds of component A) may also be completely or partly blocked with blocking agents customary known per se to the person skilled in the art.

Examples of these are alcohols, lactams, oximes, malonic esters, alkyl acetoacetates, triazoles, phenols, imidazoles, pyrazoles and amines, such as, for example, butanone oxime, diisopropylamine, 1,2,4-triazole, dimethyl-1,2,4-triazole, imidazole, diethyl malonate, ethyl acetoacetate, acetone oxime, 3,5-dimethylpyrazole, ε-caprolactam, N-tert-butylbenzylamine, cyclopentanone carboxyethyl ester or any desired mixtures of these blocking agents.

All polyfunctional, isocyanate-reactive compounds which have on average at least 1.5 isocyanate-reactive groups per molecule can be used in component B). Isocyanate-reactive groups in the context of the present invention are preferably hydroxyl, amino or thio groups.

Suitable polyfunctional, isocyanate-reactive compounds are, for example, polyester, polyether, polycarbonate, poly(meth)acrylate and/or polyurethane polyols.

Suitable polyester polyols are, for example, linear polyester diols or branched polyester polyols, as obtained in known manner from aliphatic, cycloaliphatic or aromatic di- or polycarboxylic acids or their anhydrides with polyhydric alcohols having an OH functionality of ≧2.

Examples of such di- or polycarboxylic acids or anhydrides are succinic, glutaric, adipic, pimelic, suberic, azelaic, sebacic, nonanedicarboxylic, decanedicarboxylic, terephthalic, isophthalic, o-phthalic, tetrahydrophthalic, hexahydrophthalic or trimellitic acid and acid anhydrides, such as o-phthalic, trimellitic or succinic anhydride, or any desired mixtures thereof with one another.

Examples of such suitable alcohols are ethanediol, di-, tri- or tetraethylene glycol, 1,2-propanediol, di-, tri- or tetrapropylene glycol, 1,3-propanediol, 1,4-butanediol, 1,3-butanediol, 2,3-butanediol, 1,5-pentanediol, 1,6-hexanediol, 2,2-dimethyl-1,3-propanediol, 1,4-dihydroxycyclohexane, 1,4-dimethylolcyclohexane, 1,8-octanediol, 1,10-decanediol, 1,12-dodecandiol, trimethylolpropane, glycerol or any desired mixtures thereof with one another.

The polyester polyols may also be based on natural raw materials, such as caster oil. It is also possible for the polyester polyols to be based on homo- or copolymers of lactones, as can preferably be obtained by an addition reaction of lactones or lactone mixtures, such as butyrolactone, ε-caprolactone and/or methyl-ε-caprolactone, with hydroxyl-functional compounds, such as polyhydric alcohols having an OH functionality of ≧2, for example of the abovementioned type.

Such polyester polyols preferably have number average molar masses of from 400 to 4000 g/mol, particularly preferably from 500 to 2000 g/mol. Their OH functionality is preferably from 1.5 to 3.5, particularly preferably from 1.8 to 3.0.

Suitable polycarbonate polyols are accessible in a manner known per se by reacting organic carbonates or phosgene with diols or diol mixtures.

Suitable organic carbonates are dimethyl, diethyl and diphenyl carbonate.

Suitable diols or diol mixtures comprise the polyhydric alcohols mentioned per se in relation to the polyester segments and having an OH functionality of ≧2, preferably 1,4-butanediol, 1,6-hexanediol and/or 3-methylpentanediol.

Such polycarbonate polyols preferably have number average molar masses of from 400 to 4000 g/mol, particularly preferably from 500 to 2000 g/mol. The OH functionality of these polyols is preferably from 1.8 to 3.2, particularly preferably from 1.9 to 3.0.

Suitable polyether polyols are polyadducts of cyclic ethers with OH- or NH-functional initiator molecules, which polyadducts optionally have a block structure.

Suitable cyclic ethers are, for example, styrene oxides, ethylene oxide, propylene oxide, tetrahydrofuran, butylene oxide, epichlorohydrin and any desired mixtures thereof.

Initiators which may be used are the polyhydric alcohols mentioned per se in relation to the polyester segments and having an OH functionality of ≧2 and primary or secondary amines and aminoalcohols.

Such polyether polyols preferably have number average molar masses of from 250 to 10 000 g/mol, particularly preferably from 500 to 4000 g/mol and very particularly preferably from 600 to 2000 g/mol. The OH functionality is preferably from 1.5 to 4.0, particularly preferably from 1.8 to 3.0.

In addition, aliphatic, araliphatic or cycloaliphatic di-, tri- or polyfunctional alcohols which have a low molecular weight, i.e. molecular weights of less than 500 g/mol, and are short-chain, i.e. contain 2 to 20 carbon atoms, are also suitable as polyfunctional, isocyanate-reactive compounds as constituents of component B).

These may be, for example, ethylene glycol, diethylene glycol, triethylene glycol, tetraethylene glycol, dipropylene glycol, tripropylene glycol, 1,2-propanediol, 1,3-propanediol, 1,4-butanediol, neopentyl glycol, 2-ethyl-2-butylpropanediol, trimethylpentanediol, diethyloctanediol positional isomers, 1,3-butylene glycol, cyclohexanediol, 1,4-cyclohexanedimethanol, 1,6-hexanediol, 1,2- and 1,4-cyclohexanediol, hydrogenated bisphenol A (2,2-bis(4-hydroxycyclohexyl)propane), 2,2-dimethyl-3-hydroxypropyl 2,2-dimethyl-3-hydroxypropionate. Examples of suitable triols are trimethylolethane, trimethylolpropane or glycerol. Suitable alcohols having a higher functionality are ditrimethylolpropane, pentaerythritol, dipentaerythritol or sorbitol.

Also suitable are aminoalcohols, such as, for example, ethanolamine, diethanolamine, 2-(N,N-dimethylamino)ethylamine, N-methyldiethanolamine, N-methyldiisopropanolamine, N-ethyldiethanolamine, N-ethyldiisopropanolamine, N,N′-bis(2-hydroxyethyl)perhydropyrazine, N-methylbis(3-aminopropyl)amine, N-methylbis(2-aminoethyl)amine, N,N′-,N″-trimethyldiethylenetriamine, N,N-dimethylaminoethanol, N,N-diethylaminoethanol, 1-N,N-diethylamino-2-aminoethane, 1-N,N-diethylamino-3-aminopropane, 2-dimethylaminomethyl-2-methyl-1,3-propanediol, N-isopropyldiethanolamine, N-butyldiethanolamine, N-isobutyldiethanolamine, N-oleyldiethanolamine, N-stearyldiethanolamine, oxyethylated coconut fatty amine, N-allyldiethanolamine, N-methyldiisopropanolamine, N,N-propyldiisopropanolamine, N-butyldiisopropanolamine and/or N-cyclohexyldiisopropanolamine.

In component C), α,β-unsaturated carboxylic acid derivatives, such as acrylates, methacrylates, maleates, fumarates, maleimides, acrylamides and furthermore vinyl ethers, propylene ether, allyl ether and compounds containing dicyclopentadienyl units and olefinically unsaturated compounds, such as styrene, α-methylstyrene, vinyltoluene, vinylcarbazole, olefins, such as, for example, 1-octene and/or 1-decene, vinyl esters, such as, for example, ®VeoVa 9 and/or ®VeoVa 10 from Shell, (meth)acrylonitrile, (meth)acrylamide, methacrylic acid, acrylic acid and any desired mixtures thereof may be used. Acrylates and methacrylates are preferred, and acrylates are particularly preferred.

Esters of acrylic acid or methacrylic acid are generally referred to as acrylates or methacrylates. Examples of acrylates and methacrylates which may be used are methyl acrylate, methyl methacrylate, ethyl acrylate, ethyl methacrylate, ethoxyethyl acrylate, ethoxyethyl methacrylate, n-butyl acrylate, n-butyl methacrylate, tert-butyl acrylate, tert-butyl methacrylate, hexyl acrylate, hexyl methacrylate, 2-ethylhexyl acrylate, 2-ethylhexyl methacrylate, butoxyethyl acrylate, butoxyethyl methacrylate, lauryl acrylate, lauryl methacrylate, isobornyl acrylate, isobornyl methacrylate, phenyl acrylate, phenyl methacrylate, p-chlorophenyl acrylate, p-chlorophenyl methacrylate, p-bromophenyl acrylate, p-bromophenyl methacrylate, trichlorophenyl acrylate, trichlorophenyl methacrylate, tribromophenyl acrylate, tribromophenyl methacrylate, pentachlorophenyl acrylate, pentachlorophenyl methacrylate, pentabromophenyl acrylate, pentabromophenyl methacrylate, pentabromobenzyl acrylate, pentabromobenzyl methacrylate, phenoxyethyl acrylate, phenoxyethyl methacrylate, phenoxyethoxyethyl acrylate, phenoxyethoxyethyl methacrylate, 2-naphthyl acrylate, 2-naphthyl methacrylate, 1,4-bis-(2-thionaphthyl)-2-butyl acrylate, 1,4-bis-(2-thionaphthyl)-2-butyl methacrylate, bisphenol A diacrylate, bisphenol A dimethacrylate, tetrabromobisphenol A diacrylate, tetrabromobisphenol A dimethacrylate, 2,2,2-trifluoroethyl acrylate, 2,2,2-trifluoroethyl methacrylate, 1,1,1,3,3,3-hexafluoroisopropyl acrylate, 1,1,1,3,3,3-hexafluoroisopropyl methacrylate, 2,2,3,3,3-pentafluoropropyl acrylate and/or 2,2,3,3,3-pentafluoropropyl methacrylate.

Epoxy acrylates also suitable as component C) can be obtained as reaction products of bisphenol A diglycidyl ether with hydroxyalkyl(meth)acrylates and carboxylic acids, the bisphenol A diglycidyl ether first being reacted with hydroxyalkyl(meth)acrylate with catalysis by Lewis acid and this hydroxyl-functional reaction product then being esterified with a carboxylic acid by a method known to the person skilled in the art. Bisphenol A diglycidyl ether itself and brominated variants, such as, for example, tetrabromobisphenol A diglycidyl ether (from Dow Chemical, D.E.R. 542), can advantageously be used as the diepoxide. All hydroxyl-functional acrylates described above can be used as hydroxyalkyl(meth)acrylates, in particular 2-hydroxyethyl acrylate, hydroxypropyl acrylate, 4-hydroxybutyl acrylate, poly(ε-caprolactone) mono (meth)acrylates and poly(ethylene glycol) mono(meth)acrylates. All monofunctional carboxylic acids are in principle suitable as the carboxylic acid, in particular those having aromatic substituents. Propane-2,2-diylbis[(2,6-dibromo-4,1-phenylene)oxy(2-{[3,3,3-tris(4-chlorophenyl)propanoyl]oxy}propane-3,1-diyl)oxyethane-2,1-diyl]diacrylate has proved to be a preferred compound of this class of epoxy acrylates.

Vinylaromatics suitable for component C) are styrene, halogenated derivatives of styrene, such as, for example, 2-chlorostyrene, 3-chlorostyrene, 4-chlorostyrene, 2-bromostyrene, 3-bromostyrene, 4-bromostyrene, p-(chloromethyl)styrene, p-(bromomethyl)styrene or 1-vinylnaphthalene, 2-vinylnaphthalene, 2-vinylanthracene, N-vinylpyrrolidone, 9-vinylanthracene, 9-vinylcarbazole or difunctional compounds, such as divinylbenzene. Vinyl ethers, such as, for example, butyl vinyl ether, are also suitable.

Preferred compounds of component C) are 9-vinylcarbazole, vinylnaphthalene, bisphenol A diacrylate, tetrabromobisphenol A diacrylate, 1,4-bis-(2-thionaphthyl)-2-butyl acrylate, pentabromophenyl acrylate, naphthyl acrylate and propane-2,2-diylbis[(2,6-dibromo-4,1-phenylene)oxy(2-{[3,3,3-tris(4-chlorophenyl)propanoyl]-oxy}propane-3,1-diyl)oxyethane-2,1-diyl]diacrylate.

One or more free radical stabilizers are used as component D). Inhibitors and antioxidants, as described in “Methoden der organischen Chemie [Methods of Organic Chemistry]” (Houben-Weyl), 4th edition, volume XIV/1, page 433 et seq., Georg Thieme Verlag, Stuttgart 1961, are suitable. Suitable classes of substances are, for example, phenols, such as for example, 2,6-di-tert-butyl-4-methylphenol, cresols, hydroquinones, benzyl alcohols, such as benzhydrol, optionally also quinones, such as, for example, 2,5-di-tert-butylquinone, optionally also aromatic amines, such as diisopropylamine or phenothiazine. Preferred free radical stabilizers are 2,6-di-tert-butyl-4-methylphenol, phenothiazine and benzhydrol.

One or more photoinitiators are used as component E). These are usually initiators which can be activated by actinic radiation and initiate a free radical polymerization of the corresponding polymerizable groups. Photoinitiators are commercially sold compounds known per se, a distinction being made between monomolecular (type I) and bimolecular (type II) initiators. (Type I) systems are, for example, aromatic ketone compounds, e.g. benzophenones, in combination with tertiary amines, alkylbenzophenones, 4,4′-bis(dimethylamino)benzophenone (Michler's ketone), anthrone and halogenated benzophenones or mixtures of said types. (Type II) initiators, such as benzoin and its derivatives, benzyl ketals, acylphosphine oxides, e.g. 2,4,6-trimethylbenzoyldiphenylphosphine oxide, bisacylophosphine oxides, phenylglyoxylic acid esters, camphorquinone, α-aminoalkylphenones, α,α-dialkoxyacetophenones, 1-[4-(phenylthio)phenyl]octane-1,2-dione-2-(O-benzoyloxime) and α-hydroxyalkylphenones, are furthermore suitable. The photoinitiator systems described in EP-A 0223587 and consisting of a mixture of an ammonium arylborate and one or more dyes can also be used as a photoinitiator. For example, tetrabutylammonium triphenylhexylborate, tetrabutylammonium tris-(3-fluorophenyl)hexylborate and tetramethylammonium tris-(3-chloro-4-methylphenyl)hexylborate are suitable as the ammonium arylborate. Suitable dyes are, for example, new methylene blue, thionine, Basic Yellow, pinacyanol chloride, rhodamine 60, gallocyanine, ethyl violet, Victoria Blue R, Celestine Blue, quinaldine red, crystal violet, brilliant green, Astrazon Orange G, Darrow Red, pyronine Y, Basic Red 29, pyrillium 1, cyanine, methylene blue and azure A.

It may also be advantageous to use mixture of these compounds. Depending on the radiation source used for curing, type and concentration must be adapted to photoinitiator in a manner known to the person skilled in the art. Further details are described, for example, in P. K. T. Oldring (Ed.), Chemistry & Technology of UV & EB Formulations For Coatings, Inks & Paints, vol. 3, 1991, SITA Technology, London, pages 61-328.

Preferred photoinitiators are 2,4,6-trimethylbenzoyldiphenylphosphine oxide, 1-[4-(phenylthio)phenyl]octane-1,2-dione-2-(O-benzoyloxime) and mixtures of tetrabutylammonium tris(3-fluorophenyl)hexylborate, tetramethylammonium tris(3-chloro-4-methylphenyl)hexylborate with dyes, such as, for example, methylene blue, new methylene blue, azure A, pyrillium 1, cyanine, gallocyanine, brilliant green, crystal violet and thionine.

Furthermore, one or more catalysts may be used in the PU systems according to the invention. These preferably catalyze the urethane formation. Amines and metal compounds of the metals tin, zinc, iron, bismuth, molybdenum, cobalt, calcium, magnesium and zirconium are preferably suitable for this purpose. Tin octanoate, zinc octanoate, dibutyltin dilaurate, dimethyltin dicarboxylate, iron(III) acetylacetonate, iron(II) chloride, zinc chloride, tetraalkylammonium hydroxides, alkali metal hydroxides, alkali metal alcoholates, alkali metal salts of long-chain fatty acids having 10 to 20 carbon atoms and optionally OH side groups, lead octanoate or tertiary amines, such as triethylamine, tributylamine, dimethylbenzylamine, dicyclohexylmethylamine, dimethylcyclohexylamine, N,N,N′,N′-tetramethyldiaminodiethylether, bis(dimethylaminopropyl)urea, N-methyl- or N-ethylmorpholine, N,N′-dimorpholinodiethyl ether (DMDEE), N-cyclohexylmorpholine, N,N,N′,N′-tetramethylethylenediamine, N,N,N′,N′-tetramethylbutanediamine, N,N,N′,N′-tetramethyl-1,6-hexanediamine, pentamethyldiethylenetriamine, dimethylpiperazine, N-dimethylaminoethylpiperidine, 1,2-dimethylimidazole, N-hydroxypropylimidazole, 1-azabicyclo[2.2.0]octane, 1,4-diazabicyclo[2.2.2]octane (Dabco), or alkanolamine compounds such as triethanolamine, triisopropanolamine, N-methyl- and N-ethyldiethanolamine, dimethylaminoethanol, 2-(N,N-dimethylaminoethoxy)ethanol, or N-tris(dialkylaminoalkyl)hexahydrotriazines, e.g. N,N′,N-tris(dimethylaminopropyl)-s-hexahydrotriazine, diazabicyclononane, diazabicycloundecane, 1,1,3,3-tetramethylguanidine, 1,3,4,6,7,8-hexahydro-1-methyl-2H-pyrimido(1,2-a)pyrimidine, are particularly preferred.

Particularly preferred catalysts are dibutyltin dilaurate, dimethyltin dicarboxylate, iron(III) acetylacetonate, 1,4-diazabicyclo[2.2.2]octane, diazabicyclononane, diazabicycloundecane, 1,1,3,3-tetramethylguanidine and 1,3,4,6,7,8-hexahydro-1-methyl-2H-pyrimido(1,2-a)pyrimidine.

In addition, further auxiliaries and additives may also be present in the PU systems according to the invention. These are, for example, solvents, plasticizers, leveling agents, antifoams or adhesion promoters, but also polyurethanes, thermoplastic polymers, oligomers, and further compounds having functional groups, such as, for example acetals, epoxide, oxetanes, oxazolines, dioxolanes and/or hydrophilic groups, such as, for example, salts and/or polyethylene oxides.

Preferably used solvents are readily volatile solvents having good compatibility with the 2-component formulations according to the invention, for example ethyl acetate, butyl acetate or acetone.

Liquids having good dissolution properties, low volatility and a high boiling point are preferably used as plasticizers; these may be, for example, diisobutyl adipate, di-n-butyl adipate, dibutyl phthalate, non-hydroxy-functional polyethers, such as, for example, polyethylene glycol dimethyl ether having a number average molar mass of from 250 g/mol to 2000 g/mol or polypropylene glycol and mixtures of said compounds.

It may also be advantageous simultaneously to use a plurality of additives of one type. Of course, it may also be advantageous to use a plurality of additives of a plurality of types.

The mixture of the components B) to E) and optionally catalysts and auxiliaries and additives usually consists of

24.999-99.899% by weight of component B)
0.1-75% by weight of component C)
0-3% by weight of component D)
0.001-5% by weight of component E)
0-4% by weight of catalysts
0-50% by weight of auxiliaries and additives.

The mixture preferably consists of

86.998-97.998% by weight of component B)
2-13% by weight of component C)
0.001-1% by weight of component D)
0.001-1% by weight of component E)
0-2% by weight of catalysts
0-15% by weight of auxiliaries and additives.

The mixture likewise preferably consists of

44.8-87.8% by weight of component B)
12.5-55% by weight of component C)
0.1-3% by weight of component D)
0.1-3% by weight of component E)
0-3% by weight of catalysts
0-50% by weight of auxiliaries and additives.

The molar ratio of NCO to OH is typically from 0.5 to 2.0, preferably from 0.90 to 1.25.

The PU systems according to the invention are usually obtained by a procedure in which first all components, except for the polyisocyanates A) are mixed with one another. This can be achieved by all methods and apparatuses known per se to the person skilled in the art from mixing technology, such as, for example stirred vessels or both dynamic and static mixers. The temperatures during this procedure are from 0 to 100° C., preferably from 10 to 80° C., particularly preferably from 20 to 60° C. This mixture can immediately be further processed or can be stored as a storage-stable, intermediate, optionally for several months.

If necessary, degassing can also be carried out under a vacuum of, for example, 1 mbar.

The mixing with the polyisocyanate component A) is then effected shortly before the application, it likewise being possible to use the customary mixing techniques. However, apparatuses without any, or with only little dead space are preferred. Furthermore, methods in which the mixing is effected within a very short time and with very vigorous mixing of the two mixed components are preferred. Dynamic mixers, in particular those in which the components A) and B) to E) first come into contact with one another in the mixer are particularly suitable for this purpose. This mixing can be effected at temperatures of from 0 to 80° C., preferably at from 5 to 50° C., particularly preferably from 10 to 40° C. The mixture of the two components A and B can optionally also be degassed after the mixing under a vacuum of, for example, 1 mbar in order to remove the residual gases and to prevent the formation of bubbles in the polymer layer. The mixing gives a clear, liquid formulation which, depending on the composition, cures within a few seconds to a few hours at room temperature.

The PU systems according to the invention are preferably adjusted so that the curing at room temperature begins within minutes to one hour. In a preferred embodiment, the curing is accelerated by heating the formulation after mixing to temperatures between 30 and 180° C., preferably from 40 to 120° C., particularly preferably from 50 to 100° C.

Immediately after mixing of all components, the polyurethane systems according to the invention have viscosities at room temperature of, typically from 10 to 100 000 mPa·s, preferably from 100 to 20 000 mPa·s, particularly preferably from 200 to 10 000 mPa·s, especially preferably from 500 to 1500 mPa·s, so that they have very good processing properties even in solvent-free form. In a solution with suitable solvents viscosities at room temperature of less than 10 000 mPa·s, preferably less than 2000 mPa·s, particularly preferably less than 500 mPa·s, can be established.

Systems which cure in an amount of 15 g and with a catalyst content of 0.004% within 4 hours or at a catalyst content of 0.02% in less than 10 minutes have proven to be advantageous.

The present invention furthermore relates to the polymers obtainable from PU systems according to the invention.

These preferably have glass transition temperatures of less than −10° C., preferably less than −25° C. and particularly preferably less than 40° C.

According to a preferred process the formulation according to the invention is applied directly after mixing to a substrate it being possible to use all customary methods known to the person skilled in the art in coating technology; in particular, the coating can be applied by knife coating, casting, printing, screen printing, spraying or inkjet printing.

The substrates may be plastic, metal, wood, paper, glass, ceramic and composite materials comprising a plurality of these materials, in a preferred embodiment the substrate having the form of a sheet.

In a preferred embodiment, the coating of the substrate with the formulation is carried out in a continuous process. As a rule the formulation according to the invention is applied as a film having a thickness of from 5 mm to 1 μm, preferably from 500 μm to 5 μm, particularly preferably from 50 μm to 8 μm and very particularly preferably from 25 μl to 10 μm to the substrate.

In the case of a sheet as a substrate, flexible, coated sheets are thus obtained, which sheets, in the case of a continuous process, can be rolled up after curing and thus stored over several months.

In a further preferred embodiment, the formulation is applied so that it is covered on both sides by transparent substrates, in particular plastic or glass, for this purpose the formulation being poured between the substrates held at an exact spacing of from 1 to 2 mm, preferably from 1.2 to 1.8 mm, particularly preferably from 1.4 to 1.6 mm, in particular 1.5 mm, and the substrates being kept at the exact spacing until the formulation has completely solidified and can no longer flow.

The materials used as the substrate can of course have a plurality of layers. It is possible both for the substrate to consist of layers of a plurality of different materials and for it additionally to have, for example, coatings having additional properties, such as improved adhesion, enhanced hydrophobic or hydrophilic properties, improved scratch resistance, antireflection properties in certain wavelength ranges, improved evenness of the surface, etc.

The materials obtained by one of the methods described can then be used for the recording of holograms. For this purpose, two light beams are caused to interfere in the material by a method known to the person skilled in the art of holography (P. Hariharan, Optical Holography 2nd Edition, Cambridge University Press, 1996) so that a hologram forms. The exposure of the hologram can be effected both by continuous and by pulsed irradiation. It is optionally also possible to produce more than one hologram by exposure in the same material and at the same point, it being possible to use, for example, the angle multiplexing method known to the person skilled in the art of holography. After the exposure of the hologram, the material can optionally also be exposed to a strong, broadband light source and the hologram then used without further necessary processing steps. The hologram can optionally also be further processed by further processing steps, for example transfer to another substrate, deformed, insert-molded, adhesively bonded to another surface, or covered with a scratch-resistant coating.

The holograms produced by one of the processes described can serve for data storage, for the representation of images which serve, for example, for the three-dimensional representation of persons or objects and for the authentification of a person or of an article, for the production of an optical element having the function of a lens, a mirror, a filter, a diffusion screen, a diffraction element, an optical waveguide and/or a mask.

The invention therefore furthermore relates to the use of the PU systems according to the invention in the production of holographic media, and to the holographic media as such.

### EXAMPLES

The viscosities of the respective formulations were measured without the urethanization catalyst (component B5). All viscosities were determined using a cone-and-plate viscometer (Anton Paar MCR 51 brand, viscosity over increasing shear rate 10-1000/sec) at 23®C.

The curing time was determined in each case by the following method:

15 grams of the respective formulation without the urethanization catalyst (component B5) were weighed into a polyethylene plastic vessel and completely mixed by means of a suitable mixer. Thereafter, the urethanization catalyst (component B5) was added and likewise completely mixed in. Thereafter, a metal bow was inserted into the mixture and was pulled out of the mixture and inserted again at regular intervals until it was no longer possible to pull the metal bow out of the then cured mixture. The curing time was taken as the period between the catalyst addition and the discovery that the metal bow could no longer be pulled out of the material.

Two-component formulations A to G

| Formulation | A | B | C | D | E | F | G |
|---|---|---|---|---|---|---|---|
| Component A | 4.995 g of | 4.856 g of | 5.024 g of | 4.856 g of | 7.292 g of | 4.790 g of | 4.829 g of |
| | Desmodur | Desmodur | Desmodur | Desmodur | Desmodur | Desmodur XP | Desmodur VP |
| | N100* | N3200* | N3300* | N3600* | N3800* | 2410* | LS 2294* |
| Component B1 | 8.504 g | 8.643 g | 8.475 g | 8.643 g | 6.207 g | 8.710 g | 8.670 g |
| Component B2 (6%) | 0.900 g | 0.900 g | 0.900 g | 0.900 g | 0.900 g | 0.900 g | 0.900 g |
| Component B3 (0.5%) | 0.075 g | 0.075 g | 0.075 g | 0.075 g | 0.075 g | 0.075 g | 0.075 g |
| Component B4 (0.5%) | 0.075 g | 0.075 g | 0.075 g | 0.075 g | 0.075 g | 0.075 g | 0.075 g |
| Component B5 (0.004%) | 0.006 g | 0.006 g | 0.006 g | 0.006 g | 0.006 g | 0.006 g | 0.006 g |
| Component B6 (3%) | 0.45 g | 0.45 g | 0.45 g | 0.45 g | 0.45 g | 0.45 g | 0.45 g |
| Viscosity in mPa · s at | 1280 | 910 | 981 | 725 | 2160 | 707 | 728 |
| 23° C.** | | | | | | | |
| Curing time in min at | 436 | 470 | 280 | 298 | 200 | 232 | 227 |
| 23° C. ambient temperature | | | | | | | |

*Desmodur N100: HDI biuret polyisocyanate (NCO content: 22.0%; commercial product of Bayer MaterialScience AG); Desmodur N3200: HDI biuretpolyisocyanate (NCO content: 23.0%; commercial product of Bayer MaterialScience AG); Desmodur N3300: HDI isocyanurate polyisocyanate (NCO content: 21.8%; commercial product of Bayer MaterialScience AG); Desmodur N3800: elastified HDI trimer prepolymer (NCO content: 11.0%; commercial product of Bayer MaterialScience AG); Desmodur N3600: HDI isocyanurate polyisocyanate (NCO content: 23.0%; commercial product of Bayer MaterialScience AG); Desmodur XP2410: HDI iminooxadiazinedione polyisocyanate (NCO content: 23.5%; experimental product of Bayer Material Science AG); Desmodur VP LS 2294: HDI iminooxadiazinedione polyisocyanate (NCO content 23.2%; experimental product of Bayer MaterialScience AG).
Component B1: Poly(caprolactone)polyol; Mn about 650 g/mol, equivalent weight about 325 g/mol OH
Component B2: Propane-2,2-diylbis[(2,6-dibromo-4,1-phenylene)oxy(2-{[3,3,3-tris(4-chloropheny)propanoyl]oxy}propane-3,1-diyl)oxyethane-2,1-diyl] diacrylate
Component B3: 2,4,6-Trimethylbenzoyldiphenylphosphine oxide (Darocure TPO, commercial product of Ciba Speciality Chemicals)
Component B4: Benzhydrol
Component B5: Dibutyltin dilaurate
Component B6: Dibutyl phthalate
**Viscosities were measured in the absence of component B5.

The values stated in the table show that the formulations G and H according to the invention have the overall most advantageous property combination comprising low viscosity and short curing time.

All the references described above are incorporated by reference in its entirety for all useful purposes.

While there is shown and described certain specific structures embodying the invention, it will be manifest to those skilled in the art that various modifications and rearrangements of the parts may be made without departing from the spirit and scope of the underlying inventive concept and that the same is not limited to the particular forms herein shown and described.

1. A polyurethane composition comprising
A) one or more iminooxadiazinedione-group-containing polyisocyanates,
B) one or more polyfunctional, isocyanate-reactive compounds,
C) one or more compounds having groups which react on exposure to actinic radiation with ethylenically unsaturated compounds with polymerization (radiation-curing groups),
D) optionally one or more free radical stabilizers and
E) one or more photoinitiators.

2. A polyurethane composition according to claim 1, wherein at least 60% by weight of the polyisocyanates of component A) are based on aliphatic and/or cycloaliphatic di- and/or triisocyanates.

3. A polyurethane composition according to claim 1, wherein one or more compounds of the group consisting of 9-vinylcarbazole, vinylnaphthalene, bisphenol A diacrylate, tetrabromobisphenol A diacrylate, 1,4-bis(2-thionaphthyl)-2-butyl acrylate, pentabromophenyl acrylate, naphthyl acrylate and propane-2,2-diylbis[(2,6-dibromo-4,1-phenylene)oxy(2-{[3,3,3-tris(4-chlorophenyl)propanoyl]oxy}propane-3,1-diyl)oxyethane-2,1-diyl]diacrylate are used in C).

4. A polyurethane composition according to claim 1, wherein the molar ratio of NCO to OH groups therein is from 0.90 to 1.25.

5. A polymeric plastic prepared from the polyurethane composition according to claim 1.

6. A polymeric plastic according to claim 5, wherein the polymeric plastic is a layer or molding.

7. A polymeric plastic according to claim 5, wherein the polymeric plastic has a glass transition temperature of less than −40° C.

8. Holographic media comprising a polyurethane composition according to claim 1.

9. Holographic media comprising at least one polymeric plastic according to claim 5.
